(19) United States
(12) Patent Application Publication
(10) Pub. No.: US 2013/0345897 A1
(43) Pub. Date: Dec. 26, 2013

(54) INFORMATION SERVICE SYSTEM AND NON-TRANSITORY TANGIBLE COMPUTER READABLE MEDIUM FOR THE SAME

(71) Applicant: DENSO CORPORATION, Kariya-city (JP)

(72) Inventors: Yasushi SAKUMA, Chita-gun (JP); Kazunao YAMADA, Toyota-city (JP); Toru NADA, Inazawa-city (JP)

(21) Appl. No.: 13/921,438

(22) Filed: Jun. 19, 2013

(30) Foreign Application Priority Data
Jun. 21, 2012 (JP) 2012-140064

(51) Int. Cl. G06F 17/00

(52) U.S. Cl. CPC G06F 17/00
USPC 701/1; 701/300

(57) ABSTRACT

An information service system for providing facility information includes: a restriction information obtaining device for obtaining restriction information relating to a driving condition or a user behavior; a preference information obtaining device for obtaining preference information of the user; a first information retrieving device for retrieving necessary facility information among multiple facility information items according to the restriction information; a second information retrieving device for retrieving preference facility information suited to the user preference among multiple necessary facility information items according to the preference information when the necessary facility information includes multiple necessary facility information items; and an information output device for outputting the necessary facility information or the preference facility information.

### CROSS REFERENCE TO RELATED APPLICATION

This application is based on Japanese Patent Application No. 2012-140064 filed on Jun. 21, 2012, the disclosure of which is incorporated herein by reference.

### TECHNICAL FIELD

The present disclosure relates to an information service system for providing facility information around a current position of a vehicle, and a non-transitory tangible computer readable medium for the same.

### BACKGROUND

Conventionally, an information service system for providing facility information around a current position of a vehicle receives multiple facility information items via a digital data broadcast station. The system retrieves one of the facility information items, which coincides with a category that an user has designated, among received facility information items. The system calculates a recommendation degree relating to a key word such as a price, which is input with regard to the retrieved facility information by the user. The vehicle navigation device displays the facility information such as a position of the facility and the recommendation degree (in JP-A-2006-184030).

Although the navigation device in JP-A-2006-184030 displays the recommendation degree in a map image, the device displays all facility information, which corresponds to a category that the user specifies. Thus, it may be difficult for the user to obtain the information having high recommendation degree because of the information overloaded.

In order to reduce the information amount, it is considered that the device displays only the facility information having high recommendation degree on the map image. In this case, the information is selectively chosen by only the key word, which the user inputs. Thus, it may be difficult to reflect the user character on the selected information. The user may feel a stereotypical impression.

### SUMMARY

It is an object of the present disclosure to provide an information service system for providing helpful and useful information, which is user-friendly information. It is another object of the present disclosure to provide a non-transitory tangible computer readable medium for the information service system.

According to a first aspect of the present disclosure, an information service system for providing facility information relating to a facility disposed around a current position of a vehicle, includes: a restriction information obtaining device for obtaining restriction information indicative of a restriction condition of at least one of a driving condition of the vehicle and a behavior of an user of the system; a preference information obtaining device for obtaining preference information indicative of preference of the user; a first information retrieving device for retrieving necessary facility information for the user among a plurality of facility information items in the facility information according to the restriction information; a second information retrieving device for retrieving preference facility information suited to the preference of the user among a plurality of necessary facility information items in the necessary facility information according to the preference information when the necessary facility information includes the plurality of necessary facility information items; and an information output device for outputting the necessary facility information retrieved by the first information retrieving device or the preference facility information retrieved by the first information retrieving device and the second information retrieving device.

In the above system, one of the facility information items to be output from the information output device is narrowed in view of the at least one of the driving condition of the vehicle and the behavior of the user of the system. Thus, the system limits information overload without limiting a category, which is specified by the user.

Further, when the necessary facility information includes the plurality of necessary facility information items, the system further selects the preference facility information in view of the preference of the user. Thus, the system provides the preference facility information, which reflects the characteristics of the user, without limiting to a key word input by the user.

Accordingly, the system provides helpful and useful information, which is user-friendly information.

According to a second aspect of the present disclosure, a non-transitory tangible computer readable medium includes instructions being executed by a computer. The instructions include the method for controlling the information service system according to the first aspect of the present disclosure. The method is computer-implemented.

The non-transitory tangible computer readable medium provides the preference facility information, which reflects the characteristics of the user, without limiting to a key word input by the user.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a diagram showing an information service system according to an example embodiment;

FIG. 2 is a block diagram showing a vehicle terminal apparatus;

FIG. 3 is a diagram showing functions of a management apparatus;

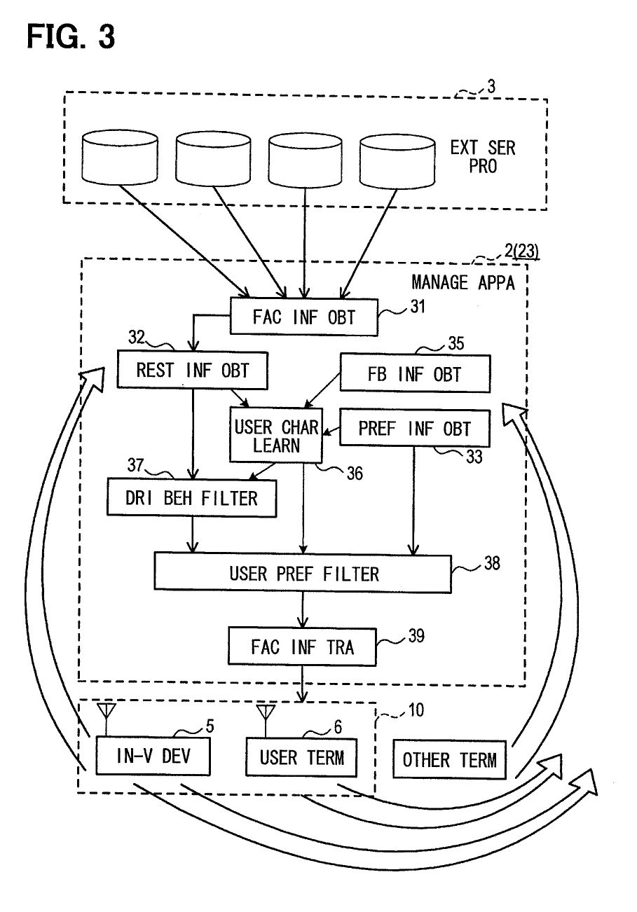

FIG. 4 is a diagram showing a driving condition list stored in a database;

FIG. 5 is a diagram showing a taste level list stored in the database;

FIG. 6 is a flowchart showing a facility information retrieving process executed by a control unit in the management apparatus;

FIG. 7 is a flowchart showing an user taste filtering process executed by the control unit in the management apparatus; and

FIG. 8 is a flowchart showing a facility information outputting process executed by a control unit in the vehicle terminal apparatus.

### DETAILED DESCRIPTION

An example embodiment of the present disclosure will be explained with reference to the drawings.

(Whole Structure)

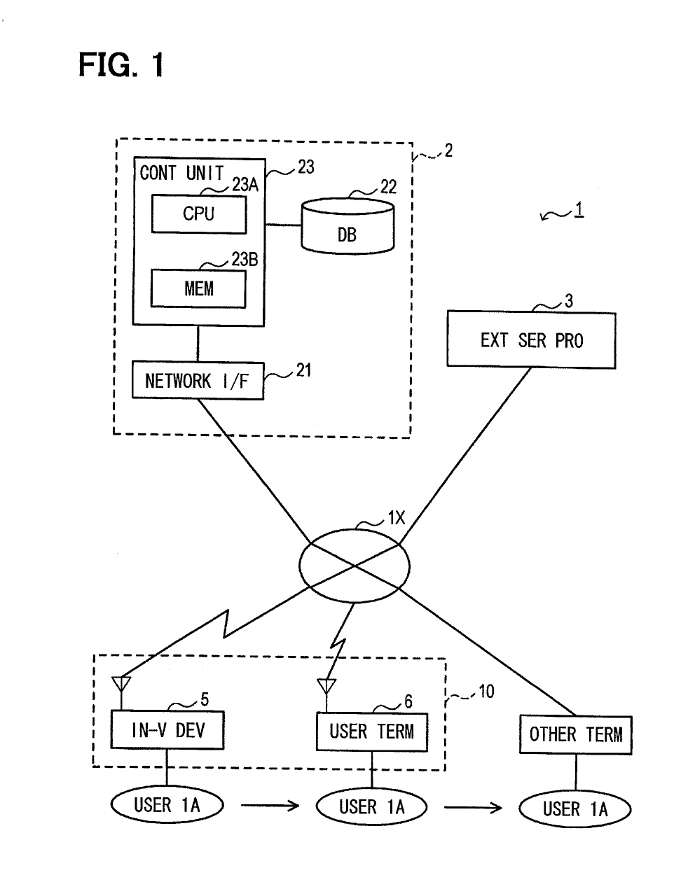

An information service system 1 in FIG. 1 provides information relating to a facility disposed around a current position of a vehicle to an user 1A. The user 1A gets on the vehicle, which is defined as a subject vehicle. The information relating to the facility is referred as facility information. The system 1 includes a management apparatus 2, an external service providing apparatus 3, an in-vehicle device 5 and a user terminal 6.

The external service providing apparatus 3 is connected to an Internet 1X. The apparatus 3 such as a web server puts various facility information on the Internet at a web-site. The facility information indicates a position of a shop as a facility, purchased goods, service, business hours, word of mouth of an user, who visits the facility, and discount. The word of mouth includes a recommendation degree. In the present embodiment, the system 1 may include one external service providing apparatus 3 or multiple external service providing apparatuses 3.

The user terminal 6 is a portable terminal device, which is carried by a user 1A, such as a cell phone, a smart phone and a tablet terminal. The user terminal 6 is connectable with an Internet 1X via a wireless communication network.

Further, the user terminal 6 has a browsing function for browsing various information, which is disclosed on a web site. For example, the terminal 6 displays facility information, which is disclosed by an external service providing apparatus 3. The terminal 6 displays map data, which is provided by another web site. Thus, the terminal 6 can search information on a web site.

The in-vehicle device 5 is, for example, a navigation device mounted on a vehicle. The device 5 displays a part of the map data around a current position of the vehicle based on the map data stored in a medium such as a hard disk drive. Further, the device 5 displays a mark indicative of the current position of the vehicle and facility information such as a position of a facility over the map data. Further, the device 5 has a function for calculating an optimum route from the current position to a destination and for performing route guidance. These functions are referred as a navigation function. The navigation function further includes a function for storing history information such as a history of destinations, which have been designated by the user, a history of parking lots of the vehicle, and a history of keywords, which have been input by the user to search information.

The in-vehicle device 5 is connected to an in-vehicle network system, which is built in the vehicle. Thus, the device 5 obtains information indicative of restriction of a driving of the vehicle, which is referred as driving restriction information. The driving restriction information indicates, for example, a remaining amount of a power source such as a fuel level and a battery level, and self failure diagnosis result performed by an electric control unit (i.e., ECU), which are transmitted from the ECU on the in-vehicle network system.

Here, the user terminal 6 has equivalent functions to the navigation function of the in-vehicle device 5 with utilizing the map data on the web site. Thus, the user terminal 6 and the in-vehicle device 5 have almost the same functions. Accordingly, both of the user terminal 6 and the in-vehicle device 5 are referred to an in-vehicle side terminal device 10. Further, in the present embodiment, the navigation function of the user terminal 6 is, in general, used in a case where the user 1A gets on the vehicle.

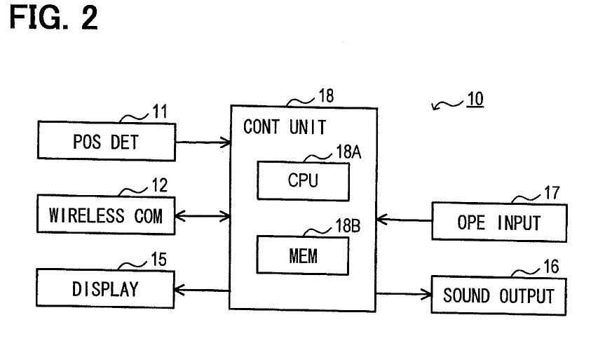

The in-vehicle side terminal device 10 includes a position detector 11, a wireless communication unit 12, a display 15, a sound output unit 16, an operation input unit 17 and a control unit 18, as shown in FIG. 2.

The position detector 11 is provided by a GPS receiver for detecting the current position of the vehicle by receiving a transmission electric wave from an artificial satellite of a GPS (grovel positioning system).

The wireless communication unit 12 is connected to the Internet 1X via the wireless communication network. For example, the unit 12 transmits information (i.e., position information) indicative of the current position detected by the position detector 11 to the management apparatus 2. Further, the unit 12 receives facility information from the management apparatus 2.

The display 15 is a liquid crystal display or an organic EL display. The display displays the map data around the current position of the vehicle. Further, the display 15 displays marks indicative of the current position of the vehicle and the position of the facility to overlap with the map data. Further, the display 15 displays an optimum route from the current position to the destination.

The sound output unit 16 outputs sound data for performing the route guidance and sound data for reading the facility information via a speaker.

The operation input unit 17 inputs an operation instruction of the user 1A via a mechanical key switch and/or a touch switch on a touch panel on the display screen of the display 15. For example, the user 1A operates the unit 17 to input a keyword for searching information, a destination in the navigation function, evaluation of the facility, and the like.

The control unit 18 controls the display 15, the sound output unit 16 and the wireless communication unit 12 based on an input signal from the operation input unit 17, the position detector 11 and the wireless communication unit 12. The control unit 18 mainly includes a micro computer having a CPU 18A and a memory 18B such as a ROM and a RAM. The CPU 18A executes a facility information output process, a process for performing the navigation function, and the like according to a program stored in the memory 18B.

The program is served by a memory medium such as an optical disk, a magnetic disk and a semiconductor memory, which stores the program provided by an information source. Alternatively, a computer accesses a network of the Internet or the like so that the computer stores the program in a server or the like. Alternatively, the computer downloads the program from a server. Thus, the control unit 18 receives the program.

(Structure of Management Apparatus)

In FIG. 1, the management apparatus 2 controls, i.e., manages the characteristics of the user 1A based on various information transmitted from the in-vehicle side terminal device 10. Further, the apparatus 2 transmits the facility information to the in-vehicle side terminal device 10. The apparatus 2 includes a network interface (network I/F) 21, a database 22, and a control unit 23.

The network I/F 21 is connected to the Internet 1X so that the I/F 21 transmits and receives various information. Thus, the I/F 21 obtains the facility information from the external service providing apparatus 3, and obtains various information from the in-vehicle side terminal device 10. Further, the I/F 21 transmits the facility information to the in-vehicle side terminal device 10.

The database 22 collects and controls data within the scope of the characteristics of the user 1A. The database 22 cooperates with the external service providing apparatus 3 so that the facility information disclosed on the web site is easily reused, i.e., searched or retrieved again.

The control unit 23 controls the network I/F 21 and the database 22. The control unit 23 mainly includes a micro computer having a CPU 23A and a memory 23B such as a ROM and a RAM. The CPU 23A executes the facility information retrieving process according to the program stored in the memory 23B.

The program is served by a memory medium such as an optical disk, a magnetic disk and a semiconductor memory, which stores the program provided by an information source. Alternatively, a computer accesses a network of the Internet or the like so that the computer stores the program in a server or the like. Alternatively, the computer downloads the program from a server. Thus, the control unit 23 receives the program.

The control unit 23 includes a facility information obtaining unit 31, a restriction information obtaining unit 32, a preference information obtaining unit 33, a FB information obtaining unit 35, a user characteristics learning unit 36, a driving behavior filter 37, a user preference filter 38 and a facility information transmitting unit 39.

The facility information obtaining unit 31 obtains the facility information, which is disclosed on a web site by the external service providing apparatus 3, via the network I/F 21.

The restriction information obtaining unit 32 obtains the position information from the in-vehicle side terminal device 10. Further, the unit 32 obtains the driving restriction information transmitted from the in-vehicle device 5, and information (i.e., behavior restriction information) indicative of the destination, the driving date and the driving place, which are designated by the user 1A trough the navigation function of the in-vehicle side terminal device 10, via the network I/F 21. Here, the driving place means an area wider than the current position of the vehicle.

The preference information obtaining unit 33 obtains information (i.e., preference information), via the network I/F 21, indicative of various histories such as the record of the destination, the parking place and the search keyword, which is stored by performing the navigation function of the in-vehicle side terminal device 10, the record of the search keyword stored by performing the browser function of the user terminal 6, and the keyword selected by the user 1A and input in a questionnaire form, which is preliminary prepared on the web site. The preference information may be obtained via the network I/F 21 from other terminals, which are used by the user 1A, in addition to the in-vehicle side terminal device 10.

The FB information obtaining unit 35 obtains information (i.e., feedback information), via the network I/F 21, indicative of an operation of the user with respect to the facility information displayed on the display 15 within a predetermined time such as an input operation of the destination and a search operation of the keyword and action of the user such as a parking action of the vehicle.

The user characteristics learning unit 36 learns the characteristics of the user 1A based on various information obtained by the restriction information obtaining unit 32, the preference information obtaining unit 33 and the FB information obtaining unit 35, and then, the unit 36 updates information in the database 22.

For example, the user characteristics learning unit 36 estimates the driving purpose of the user 1A based on the destination input by the user 1A among the behavior restriction information obtained from the restriction information obtaining unit 32 among the behavior restriction information obtained by the restriction information obtaining unit 32. Further, the unit 36 connects the driving date and the driving place, which are provided by the estimated driving purpose, with the driving scene, so that the unit 36 stores the driving scene in connection with the driving date and the driving place. Thus, the unit 36 updates the driving scene list 22A in the database 22.

In the driving scene list 22A, a restaurant for family is registered as an information category in case of a driving scene when the vehicle runs near a house of the user 1A in a daytime on holiday. A restaurant for a business person is registered as an information category in case of a driving scene when the vehicle runs near a working office of the user 1A in a daytime on a week day. A fancy restaurant is registered as an information category in case of a driving scene when the vehicle runs around a place other than the house and the working place of the user 1A in night time on a week day.

In the driving scene list 22A, the information related to the driving restriction information is registered as the information category in addition to the driving scene. For example, information about a gas station is registered as the information category with respect to a remaining amount of the gasoline.

The user characteristics learning unit 36 stores the preference information obtained by the preference information obtaining unit 33 at each restriction information such as the driving scene (that is the behavior restriction information) and the driving restriction information, so that the unit 36 updates the driving scene list 22A.

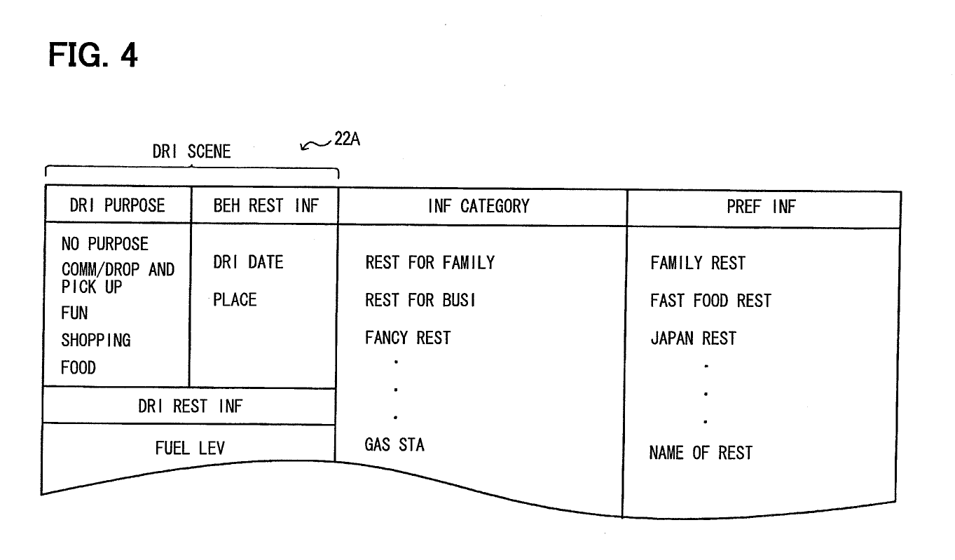

In the above case, in the driving scene list 22A, as shown in FIG. 4, the information category and the name of a place are registered as the preference information according to the history information of the user 1A. For example, the family restaurant is registered as an eating place for family, a fast food restaurant is registered as an eating place for a business person, and a Japanese restaurant is registered as a little expensive eating place. Here, the information category includes the family restaurant, the fast food restaurant and the Japanese restaurant.

Further, the user characteristics learning unit 36 registers a level value (i.e., a preference level) in each preference information item, indicative of a degree of the preference of the user 1A, according to the feedback information obtained by the FB information obtaining unit 35, so that the unit 36 updates the preference level list 22B in the database 22.

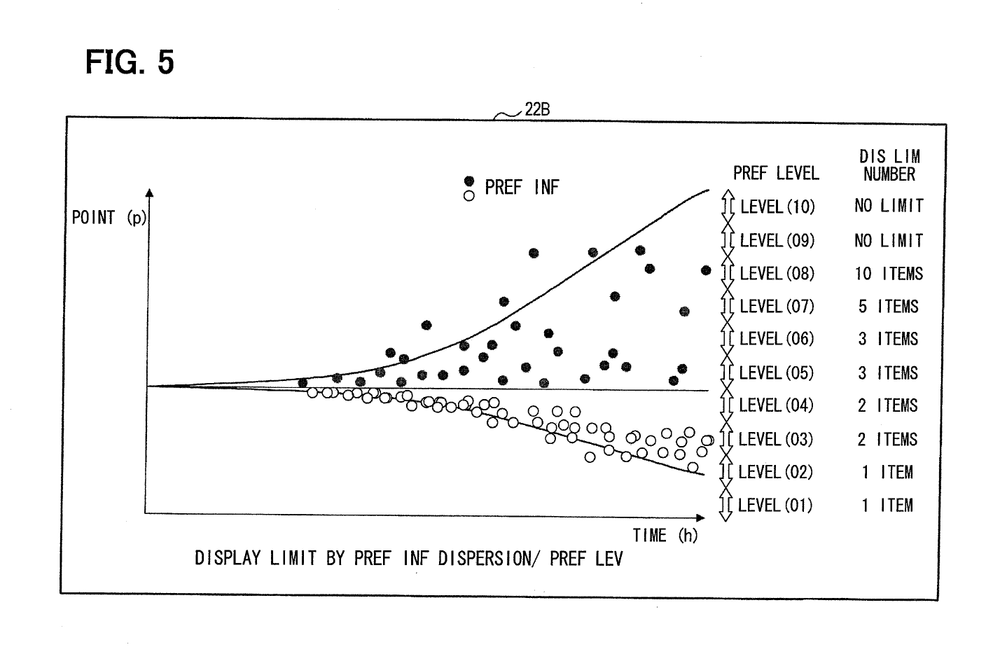

As shown in FIG. 5, in the preference level list 22B, the preference level is connected to each preference information item. Further, the limitation number of the facility information items to be provided to the user 1A is preliminary determined in accordance with the preference level.

For example, at each time when the feedback information is received, the user characteristics learning unit 36 increases the preference level of the preference information, which corresponds to the feedback information. When the feedback information is not received on that day, the unit 36 reduces the preference level of the preference information.

In the preference level list 22B, the user characteristics learning unit 36 sets the time limit relating to the display of the facility information so as to spread the preference information items having the same preference level in accordance with the information category. For example, the display time of the information relating to the job among the facility information, which corresponds to the preference information, is set to be longer. The display time of the information relating to the leisure is set to be shorter.

The driving behavior filter 37 retrieves the facility information relating to facilities around the vehicle based on the position information obtained by the restriction information obtaining unit 32 and the facility information obtained by the facility information obtaining unit 31. Further, the filter 37 refers to the driving scene list 22A of the database 22 so that the filter 37 retrieves the necessary information for the user such as the eating place for the business person based on the restriction information obtained by the restriction information obtaining unit 32 and the retrieved facility information relating to the facilities around the vehicle.

The user preference filter 38 refers to the driving scene list 22A of the database 22 so that the filter 38 retrieves the information suited to the user preference such as a fast food restaurant among multiple facility information items based on the preference information obtained by the preference information obtaining unit 33 when multiple facility information items are retrieved by the driving behavior filter 37.

The facility information transmitting unit 39 transmits the facility information retrieved by the user preference filter 38 and the driving behavior filter 37 to the in-vehicle side terminal device 10, which is a transmission source of the position information, via the network I/F 21. Here, the facility information to be transmitted includes time information indicative of the display time (i.e., restriction time) based on the preference level list 22B of the database 22.

(Facility Information Retrieving Process)

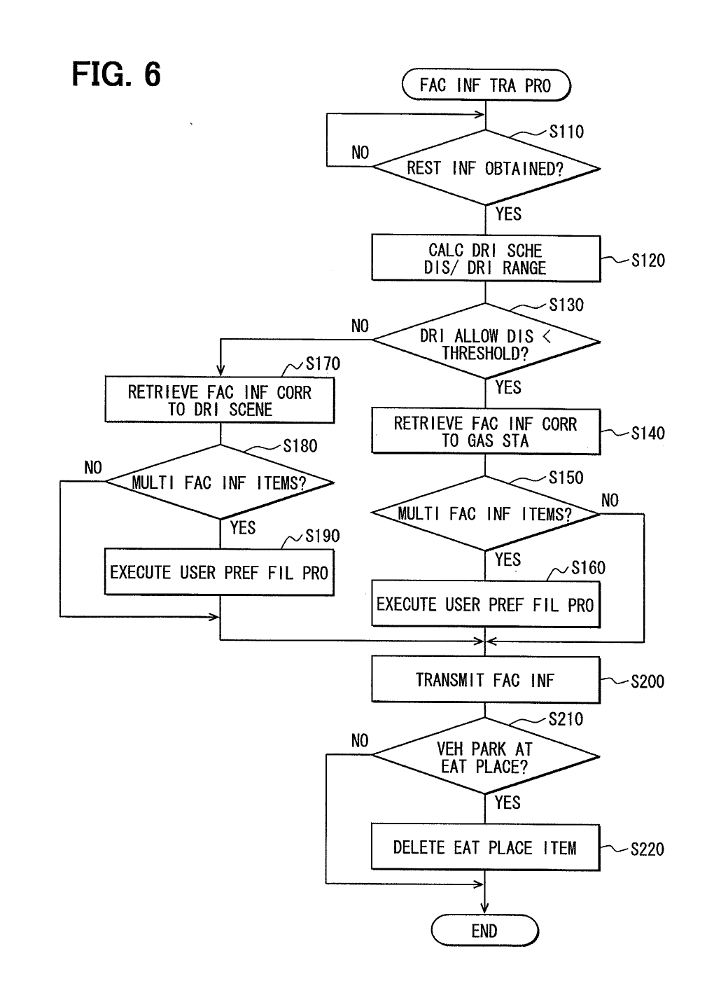

Next, an example of the facility information retrieving process executed by the CPU 23A of the control unit 23 will be explained with reference to FIG. 6. The facility information retrieving process is provided by the user preference filter 38 and the driving behavior filter 37. Here, the CPU 23A starts to execute the facility information retrieving process when the restriction information obtaining unit 32 obtains the position information from the in-vehicle side terminal device 10.

When the CPU 23A starts to execute the facility information retrieving process, in step S110, the CPU 23A determines the restriction information together with the position information is received from the in-vehicle side terminal device 10 via the network I/F 21. When the determination in step S110 is positive, it goes to step S120. When the determination in step S110 is negative, it returns to step S110 so that the CPU 23A stands by until the restriction information is received.

At step S120, the CPU 23A calculates the distance (i.e., the driving schedule distance or calculated route distance) from the current position of the vehicle to the destination based on the behavior restriction information and the position information received at step S110. Further, the CPU 23A estimates the driving range (i.e., the maximum fuel range distance) according to the remaining amount of gasoline, which is provided by the driving restriction information received at step S110.

At step S130, the CPU 23A determines whether a distance (i.e., “driving allowance distance”) obtained by subtracting the calculated route distance from the maximum fuel range distance falls below a predetermined threshold distance. When the determination in step S130 is positive, it goes to step S140. When the determination in step S130 is negative, it goes to step S180.

At step S140, the CPU 23A selects a gas station as the information category from the driving scene list 22A of the database 22. Further, the CPU 23A retrieves the facility information relating to the gas station around the current position of the vehicle according to the facility information disclosed on the web site by the external service providing apparatus 3.

At step S150, the CPU 23A determines whether multiple facility information items retrieved at step S140 exist. When the determination in step S150 is positive, it goes to step S160. When the determination in step S150 is negative, it goes to step S200.

At step S160, the CPU 23A reads out the preference information such as the name of the gas station corresponding to the information category selected at step S140 from the driving scene list 22A of the database 22. Then, the CPU 23A executes the user preference filtering process for retrieving a corresponding or similar facility information of the preference information read out. Then, it goes to step S200.

When the determination in step S130 is negative, i.e., when the driving allowance distance is equal to or larger than the predetermined threshold distance, it goes to step S170. At step S170, the CPU 23A selects the information category such as a restaurant for a business person, which corresponds to the driving scene, from the driving scene list 22A of the database 22 according to the behavior restriction information such as the driving date received at step S110 received at step S110. Then, the CPU 23A retrieves the facility information concerned with the selected information category among the facility information disclosed on the web site by the external service providing apparatus 3.

At step S180, the CPU 23A determines whether multiple facility information items retrieved at step S170 exist. When the determination in step S170 is positive, it goes to step S190. When the determination in step S180 is negative, it goes to step S200.

At step S190, the CPU 23A executes a user preference filtering process. Specifically, at step S190, the CPU 23A reads out the preference information such as the fast food restaurant corresponding to the information category selected at step S170 from the driving scene list 22A of the database 22. Then, the CPU 23A retrieves the facility information, which coincides with or is similar to the preference information. Then, it goes to step S200.

At step S200, the facility information retrieved at step S190 is transmitted to the in-vehicle side terminal device 10 via the network I/F 21. Then, it goes to step S210.

At step S210, the CPU 23A determines based on the feedback information received from the in-vehicle side terminal device 10 via the network I/F 21 whether a driver parks the vehicle at an eating place. When the determination in step S210 is positive, it goes to step S220. When the determination in step S210 is negative, the CPU 23A competes the present process.

At step S220, the CPU 23A prohibits from retrieving and transmitting the facility information relating to the eating place by deleting an item relating to the eating place from the information category and the preference information with respect to the user 1A in the driving scene list 22A of the database 22 for a predetermined time interval. Then, the CPU 23A ends the present process.

Here, steps S210, S220 are examples of deleting information relating to the behavior of the user 1A based on the feedback information. Alternatively, the information relating to the operation of the user 1A may be deleted. For example, the CPU 23A may prohibit from retrieving and transmitting the facility information relating to the fast food restaurant by excluding the preference information corresponding to the facility information, which is input by a browsing operation of the user 1A at the in-vehicle side terminal device 10, for a predetermined time interval.

(User Preference Filtering Process)

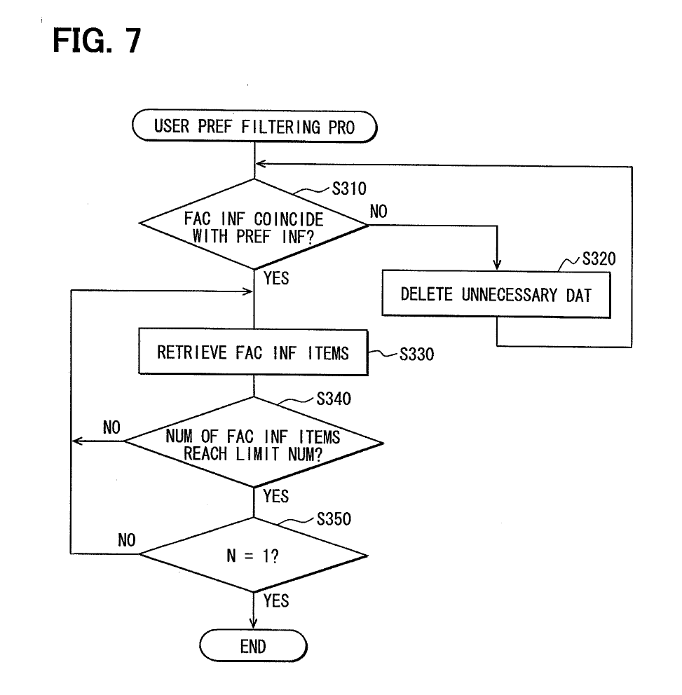

Next, an example of the user preference filtering process executed by the CPU 23A of the control unit 23 at step S160 or S190 in the facility information retrieving process will be explained with reference to FIG. 7.

When the CPU 23A starts to execute the user preference filtering process, the user preference filter 38 determines with reference to the driving scene list 22a of the database 22 at step S310 whether each facility information item near the current position of the vehicle retrieved by the driving behavior filter 37 coincides with the preference information. When the determination in step S310 is negative, i.e., when the determination of step S310 is “NO,” at step S320, the facility information item is deleted from a retrieving candidate since the item is unnecessary data.

When the determination in step S310 is “YES,” at step S330, the facility information, which coincides with or is similar to the preference information, is referred as a retrieving candidate. Further, the facility information items relating to the preference information having a preference level equal to N is retrieved one by one among the retrieving candidates with reference to the preference level list 22B of the database 22. Here, the initial value of the numeral N is ten.

Then, at step S340, the CPU 23A determines with reference to the preference level list 22B of the database 22 whether the number of the facility information items retrieved at step S330 reaches the limitation number of the facility information items corresponding to the preference level N. When the determination of step S340 is negative, i.e., when the determination of step S340 is “NO,” the CPU 23A continues to retrieve the facility information at step S330.

When the determination of step S340 is positive, i.e., when the determination of step S340 is “YES,” or when there is no facility information, which relates to the preference information having the preference level of N and is not retrieved, among the retrieving candidates, the preference level N is decremented. Then, at step S350, when the preference level N is not one, i.e., when the determination in step S350 is “NO,” it returns to step S330 so that the facility information items relating to the preference information having the preference level (N−1) are retrieved one by one.

When the facility information is retrieved until the preference level N is one, i.e., when the determination in step S350 is “YES,” the CPU 23A completes the present process. Then, all of the retrieved facility information is transmitted to the in-vehicle side terminal device 10. Here, each facility information item to be transmitted includes time information indicative of the display time as the time limit, which is derived from the preference level list 22B of the database 22.

(Facility Information Outputting Process)

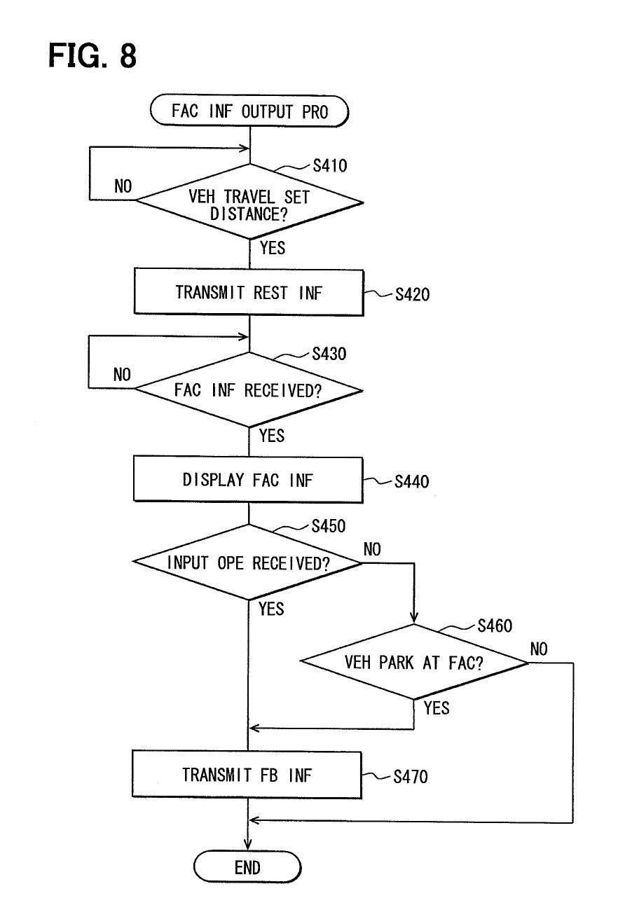

The facility information outputting process executed by the control unit 18 (i.e., the CPU 18A) of the in-vehicle side terminal device 10 will be explained with reference to FIG. 8.

When the CPU 18A starts to execute the present process, the CPU 18A determines at step S410 whether the vehicle travels for a predetermined setting distance. When the determination in step S410 is positive, i.e., when the determination in step S410 is “YES,” at step S420, the CPU 18A transmits the restriction information such as the driving restriction information and the behavior restriction information to the management apparatus 2 via the wireless communication unit 12 together with the position information.

At step S430, the CPU 18A determines whether the facility information is received from the management apparatus 2 via the wireless communication unit 12. When the determination in step S430 is positive, i.e., when the determination in step S430 is “YES,” at step S440, the display 15 displays the position of the facility indicated by the facility information to overlap on the display screen image of the map data around the current position of the vehicle. At step S450, when the CPU 18A receives the operation of the user 1A for inputting the position of the facility via the operation input unit 17, i.e., when the determination in step S450 is “YES,” the CPU 18A displays and pops up the detailed information relating to the facility information, or controls the sound output unit 16 to read out the detailed information.

When the CPU 18A receives the operation of the user 1A for inputting the position of the facility via the operation input unit 17, i.e., when the determination in step S450 is “YES,” at step S470, the CPU 18A transmits the feedback information, in which the facility information is distinguishable, to the management apparatus 2 via the wireless communication unit 12. When the user 1A parks the vehicle at the place of the facility, i.e., when the determination in step S460 is “YES,” at step S470, the CPU 18A transmits the feedback information, in which the facility information is distinguishable, to the management apparatus 2 via the wireless communication unit 12.

### EFFECTS

Thus, in the information service system 1, the management apparatus 2 retrieves the necessary information for the user 1A among multiple facility information items according to the restriction information obtained from the in-vehicle side terminal device 10. When multiple facility information items are retrieved, one of the facility information items is retrieved according to the preference of the user 1A based on the preference information, which relates to the user 1A and is preliminary obtained. Thus, the preference information is transmitted to the in-vehicle side terminal device 10.

Thus, in the information service system 1, the information item to be output and selected among multiple facility information items is narrowed to at least one of the necessary information for the driving of the vehicle and the necessary information for the behavior of the user 1A. Thus, the system 1 suppresses information overload. Further, when multiple facility information items are retrieved, the facility information items are selected according to the preference of the user 1A. Thus, the system 1 provides the information, which reflects the characteristics of the user 1A.

Accordingly, the system 1 provides the information, which is helpful and useful, and user-friendly information.

Further, in the system 1, the restriction information obtaining unit 32 obtains at least one of the destination, the driving date, and the driving place of the vehicle as the behavior restriction information. The driving behavior filter 37 estimates the driving purpose of the driver based on the behavior restriction information obtained by the restriction information obtaining unit 32, and the filter 37 retrieves the facility information according to the estimated driving purpose.

Thus, the driving purpose relating to the driving scene such as the commuting to an office or a school, the dropping and picking up, the shopping, the travel, the fun to drive, and the eating is automatically distinguished. Since the facility information determined according to the driving scene is output, the system provides the helpful and useful information to the user.

In the system 1, the in the driving scene list 22A of the database 22, the preference information obtained by the preference information obtaining unit 33 is stored at each restriction information item. The user preference filter 38 reads out the preference information, corresponding to the restriction information obtained by the restriction information obtaining unit 32, from the driving scene list 22A. Based on the read out preference information, the facility information is retrieved.

Thus, since the facility information, which is suitable for the user preference determined by the driving scene, is output, the system 1 provides the much helpful and useful information to the user.

Further, in the information service system 1, in the preference level list 22B of the database 22, the preference level is stored at each preference information item. Thus, the user preference filter 38 reads out the preference level corresponding to the preference information from the preference level list 22B. According to the read out preference level, the system 1 determines the limit number of the facility information items to be provided to the user.

Thus, since the number of the facility information items to be output is weighted with the preference level of the user 1A at each information category or each facility information, the system 1 evenly provides the information, which is suited for the preference of the user 1A. Further, the system 1 increases and decreases the number of the facility information items according to the preference level of the user 1A, so that the system 1 secures an opportunity to obtain various information, and provides the more preferable information sufficiently.

In the system 1, the FB information obtaining unit 35 obtains the feedback information with respect to the facility information output from the in-vehicle side terminal device 10, and the user characteristics learning unit 36 sets the preference level, which is stored in the preference level list 22B of the database 22, variably according to the feedback information obtained by the FB information obtaining unit 35.

Thus, since at least one of the actual operation and the actual behavior of the user 1A, which are performed in response to the output facility information, is reflected on the preference level, the system 1 can accurately detect the evaluation of the user 1A relating to the facility.

Further, the system 1 prohibits the service of the facility information, which belongs to the information category (such as food) of the facility (such as specific restaurant) that the user 1A actually goes, for a predetermined time interval according to the feedback information. Specifically, the system 1 prohibits the retrieval and the output of the facility information.

Thus, for example, when the user 1A is full up, the system 1 does not provide the facility information relating to the food. Thus, the system 1 provides only the helpful and useful information to the user 1A.

Further, in the system 1, the restriction information obtaining unit 32 obtains the driving restriction information indicative of the remaining amount of power source in the vehicle. Thus, for example, when the remaining amount of gasoline is small, the system 1 automatically provides the facility information relating to the gas station, so that the system 1 provides only the helpful and useful information to the user 1A.

Here, the driving behavior filter 37 corresponds to a first information retrieving device, the user preference filter 38 corresponds to a second information retrieving device, the facility information transmitting unit 39 corresponds to an information output device, the driving scene list 22A is provided by a first memory, the preference level list 22B is provided by a second memory, and the user characteristics learning unit 36 corresponds to a preference learning device.

### Other Embodiments

For example, in the system 1, the management apparatus 2 transmits the facility information to the in-vehicle side terminal device 10. Alternatively, the in-vehicle side terminal device 10 itself may provide the information service system 1. Specifically, the control unit 18 of the in-vehicle side terminal device 10 may include each element of the control unit 23 of the management apparatus 2, each element providing a corresponding function of the control unit 23.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. An information service system for providing facility information relating to a facility disposed around a current position of a vehicle, the system comprising:
a restriction information obtaining device for obtaining restriction information indicative of a restriction condition of at least one of a driving condition of the vehicle and a behavior of an user of the system;
a preference information obtaining device for obtaining preference information indicative of preference of the user;
a first information retrieving device for retrieving necessary facility information for the user among a plurality of facility information items in the facility information according to the restriction information;
a second information retrieving device for retrieving preference facility information suited to the preference of the user among a plurality of necessary facility information items in the necessary facility information according to the preference information when the necessary facility information includes the plurality of necessary facility information items; and
an information output device for outputting the necessary facility information retrieved by the first information retrieving device or the preference facility information retrieved by the first information retrieving device and the second information retrieving device.

2. The information service system according to claim 1, wherein:
the restriction information indicative of the restriction condition of the behavior of the user is defined as behavior restriction information;
the behavior restriction information indicates at least one of a destination, a driving date and a driving place;
the first information retrieving device estimates a driving purpose of the user based on the behavior restriction information; and
the first information retrieving device retrieves the necessary facility information suited to an estimated driving purpose.

3. The information service system according to claim 1, further comprising:
a first memory for storing the preference information in relation to each restriction information item in the restriction information, wherein:
the second information retrieving device reads out the preference information in the first memory corresponding to a restriction information item obtained by the restriction information obtaining device; and
the second information retrieving device retrieves the preference facility information based on a read-out preference information.

4. The information service system according to claim 1, further comprising:
a second memory for storing a preference level indicative of a preference degree of the user corresponding to each preference information item in the preference information, wherein:
the second information retrieving device reads out the preference level corresponding to a preference information item obtained by the preference information obtaining device; and
the second information retrieving device determines a limitation number of the facility information items, which are to be provided to the user, according to a read-out preference level.

5. The information service system according to claim 4, further comprising:
a feedback information obtaining device for obtaining feedback information indicative of at least one of an operation and the behavior, which are performed by the user in response to the necessary facility information or the preference facility information output by the information output device; and
a preference learning device for setting the preference level stored in the second memory variably according to the feedback information.

6. The information service system according to claim 1, further comprising:
a feedback information obtaining device for obtaining feedback information indicative of at least one of an operation and the behavior, which are performed by the user in response to the necessary facility information or the preference facility information output by the information output device, wherein:
the first information retrieving device deletes a facility information item relating to the at least one of the operation and the behavior performed by the user from the plurality of facility information items according to the feedback information.

7. The information service system according to claim 1, wherein:
the restriction information indicative of the restriction condition of the driving condition of the vehicle is defined as driving restriction information; and
the driving restriction information indicates a remaining amount of a power source in the vehicle.

8. A non-transitory tangible computer readable medium comprising instructions being executed by a computer, the instructions including the method for controlling the information service system according to claim 1, the method being computer-implemented.
